(19) United States
(12) Patent Application Publication
(10) Pub. No.: US 2006/0239585 A1
(43) Pub. Date: Oct. 26, 2006

(54) System and method for reducing artifacts in motion corrected dynamic image sequences

(76) Inventors: Gerardo Hermosillo Valadez, Exton, PA (US); Marcos Salganicoff, Philadelphia, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/393,516

(22) Filed: Mar. 30, 2006

Related U.S. Application Data
(60) Provisional application No. 60/668,010, filed on Apr. 4, 2005.

(51) Int. Cl. G06K 9/40

(52) U.S. Cl. 382/275

(57) ABSTRACT

A system and method for reducing artifacts in a motion corrected image sequence are provided. A method reducing an artifact in a motion corrected image sequence comprises: applying a deformation to a reference image of a plurality of post-contrast enhanced images to obtain an interpolated version of the reference image; and performing a registration between the interpolated version of the reference image and a pre-contrast enhanced image and the plurality of post-contrast enhanced images to obtain a plurality of motion corrected images.

### CROSS-REFERENCE TO RELATED APPLICATION

This application claims the benefit of U.S. Provisional Application No. 60/668,010, filed Apr. 4, 2005, a copy of which is herein incorporated by reference.

### BACKGROUND OF THE INVENTION

1. Technical Field

The present invention relates to the correction of motion in a sequence of images, and more particularly, to a system and method for reducing artifacts in motion corrected dynamic image sequences.

2. Discussion of the Related Art

The assessment of perfusion is a key issue for the diagnosis, therapeutic-planning and patient follow-up of a variety of diseases. To this end, perfusion magnetic resonance imaging (MRI) has emerged as a valuable clinical investigation tool due to its ability of dynamically imaging areas of interest in a patient's body. In particular, perfusion MRI has demonstrated a high diagnostic accuracy for the detection of diseases associated with the lungs, heart and brain. For example, by viewing post-contrast enhanced images with pre-contrast enhanced images, a physician can quickly locate suspicious regions. Since, however, patient motion introduces artifacts, this task can become difficult, time-consuming and somewhat inaccurate.

One technique for reducing the amount of artifacts introduced by patient motion involves applying a motion correction algorithm to the pre-contrast enhanced and post-contrast enhanced images. An example of motion correction applied to a perfusion image sequence of the breast is shown in FIG. 1. As shown in FIG. 1, image (a) illustrates the subtraction of a pre-contrast enhanced acquisition from a post-contrast enhanced acquisition and image (b) illustrates the same subtraction after motion correction. As can be observed, although most of the artifacts (indicated by bright white areas) in image (a) have been removed, there still exists a number of artifacts (also indicated by bright white areas) in image (b) due to residual changes in signal intensity arising from motion.

A particular artifact resulting from applying a motion correction algorithm to a perfusion image sequence is a double-vessel artifact. An example of the double-vessel artifact is indicated by the arrows in image (a) in each of FIGS. 5A through 5C and 6A. The double-vessel artifact can occur when the subtracted images are interpolated during motion correction, thus causing the intensity of high frequency structures such as the edges of parenchyma to present vessel-like structures that are doubled. Accordingly, there is a need for a motion correction technique that is capable of reducing the amount of double-vessel artifacts.

### SUMMARY OF THE INVENTION

In one embodiment of the present invention, a method for reducing an artifact in a motion corrected image sequence comprises: applying a deformation to a reference image of a plurality of post-contrast enhanced images to obtain an interpolated version of the reference image; and performing a registration between the interpolated version of the reference image and a pre-contrast enhanced image and the plurality of post-contrast enhanced images to obtain a plurality of motion corrected images.

The pre-contrast enhanced image and the plurality of post-contrast enhanced images are acquired using a magnetic resonance (MR), computed tomography (CT), positron emission tomography (PET), single photon emission computed tomography (SPECT), fluoroscopic, x-ray or ultrasound technique.

The pre-contrast enhanced image is an image acquired before a contrast agent has been administered to a patient and the plurality of post-contrast enhanced images are images acquired after the contrast agent has been administered to the patient. The pre- and post-contrast enhanced images are images of a region of interest in a patient.

The deformation is a translation, rotation, scaling or shearing. The registration is a non-rigid registration. The registration comprises: subtracting the pre-contrast enhanced image from the interpolated version of the reference image; and subtracting the plurality of post-contrast enhanced images from the interpolated version of the reference image.

The method further comprises displaying one of the plurality of motion corrected images. The artifact is a double-vessel artifact.

In another embodiment of the present invention, a system for reducing an artifact in a motion corrected image sequence comprises: a memory device for storing a program; a processor in communication with the memory device, the processor operative with the program to: apply a deformation to a reference image of a plurality of post-contrast enhanced images to obtain an interpolated version of the reference image; and perform a registration between the interpolated version of the reference image and a pre-contrast enhanced image and the plurality of post-contrast enhanced images to obtain a plurality of motion corrected images.

The pre-contrast enhanced image and the plurality of post-contrast enhanced images are acquired using an MR, CT, PET, SPECT, fluoroscopic, x-ray or ultrasound device.

The pre-contrast enhanced image is an image acquired before a contrast agent has been administered to a patient and the plurality of post-contrast enhanced images are images acquired after the contrast agent has been administered to the patient. The pre- and post-contrast enhanced images are images of a region of interest in a patient.

The deformation is a translation, rotation, scaling or shearing. The registration is a non-rigid registration. When performing the registration the processor is further operative with the program code to: subtract the pre-contrast enhanced image from the interpolated version of the reference image; and subtract the plurality of post-contrast enhanced images from the interpolated version of the reference image.

The processor is further operative with the program code to display one of the plurality of motion corrected images. The artifact is a double-vessel artifact.

In yet another embodiment of the present invention, a method for reducing double-vessel artifacts in a perfusion image sequence of a region of interest in a patient comprises: acquiring a pre-contrast enhanced image of the region of interest; acquiring a plurality of post-contrast enhanced images of the region of interest; selecting a reference image from the plurality of post-contrast enhanced images; deforming the reference image to obtain an interpolated version of the reference image; and registering the interpolated version of the reference image to the pre-contrast enhanced image and the plurality of post-contrast enhanced images to obtain a plurality of motion corrected images.

The method further comprises administering a contrast agent to the patient. The reference image is selected automatically or manually. The region of interest is a head, breast, abdomen or leg of the patient. The reference image is deformed by performing a fixed sub-pixel 2D translation. The registration is a non-rigid registration.

The foregoing features are of representative embodiments and are presented to assist in understanding the invention. It should be understood that they are not intended to be considered limitations on the invention as defined by the claims, or limitations on equivalents to the claims. Therefore, this summary of features should not be considered dispositive in determining equivalents. Additional features of the invention will become apparent in the following description, from the drawings and from the claims.

### BRIEF DESCRIPTION OF THE DRAWINGS

FIG. 1 shows a pair images for illustrating conventional motion correction;

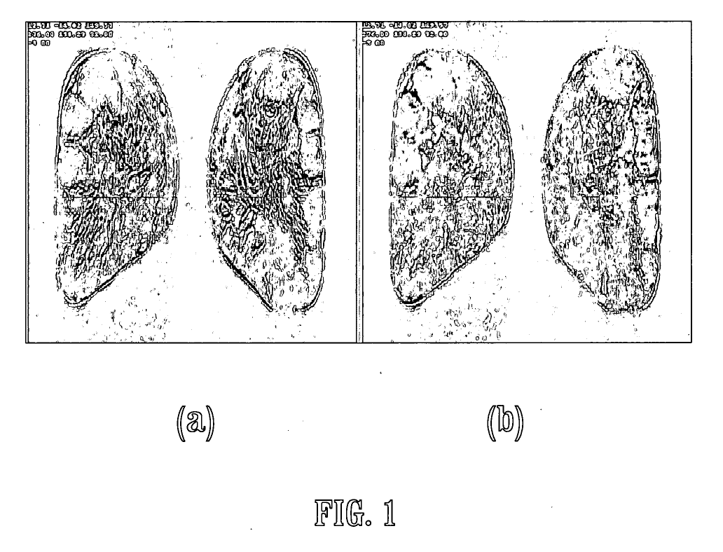

FIG. 2 shows a block diagram of a system for reducing artifacts in motion corrected dynamic image sequences according to an exemplary embodiment of the present invention;

FIG. 3 shows a flowchart of a method for reducing artifacts in motion corrected dynamic image sequences according to an exemplary embodiment of the present invention;

FIG. 4 shows a diagram for illustrating the method of FIG. 3;

FIG. 5A shows a pair of images illustrating results of the method of FIG. 3;

FIG. 5B shows another pair of images illustrating results of the method of FIG. 3;

FIG. 5C shows yet another pair of images illustrating results of the method of FIG. 3;

FIG. 6A shows a conventionally motion corrected high-resolution image; and

FIG. 6B shows the image of FIG. 6A having the method of FIG. 3 applied thereto.

### DETAILED DESCRIPTION OF EXEMPLARY EMBODIMENTS

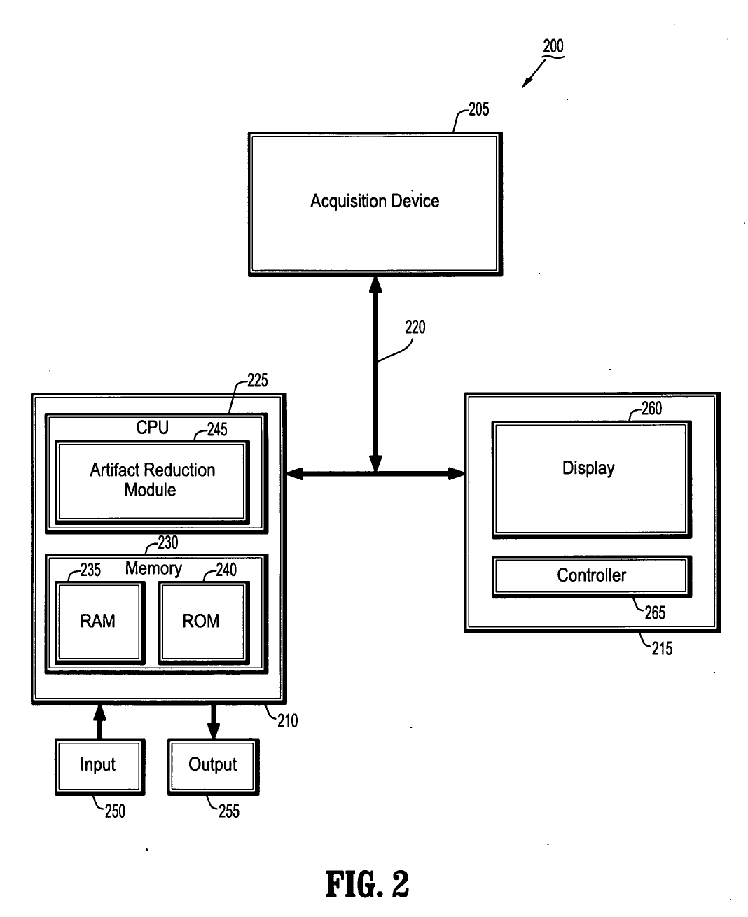

FIG. 2 is a block diagram of a system 200 for reducing artifacts in motion corrected dynamic image sequences according to an exemplary embodiment of the present invention. As shown in FIG. 2, the system 200 includes, inter alia, an acquisition device 205, a PC 210 and an operator's console 215 connected over a wired or wireless network 220.

The acquisition device 205 may be a magnetic resonance (MR) imaging device, computed tomography (CT) imaging device, helical CT device, positron emission tomography (PET) device, single photon emission computed tomography (SPECT) device, hybrid PET-CT device, hybrid SPECT-CT device, 2D or 3D fluoroscopic imaging device, 2D, 3D, or 4D ultrasound imaging device, or an x-ray device. In addition, the acquisition device may be a multi-modal or hybrid acquisition device that is capable of acquiring images, for example, in a PET mode, SPECT mode or MR mode.

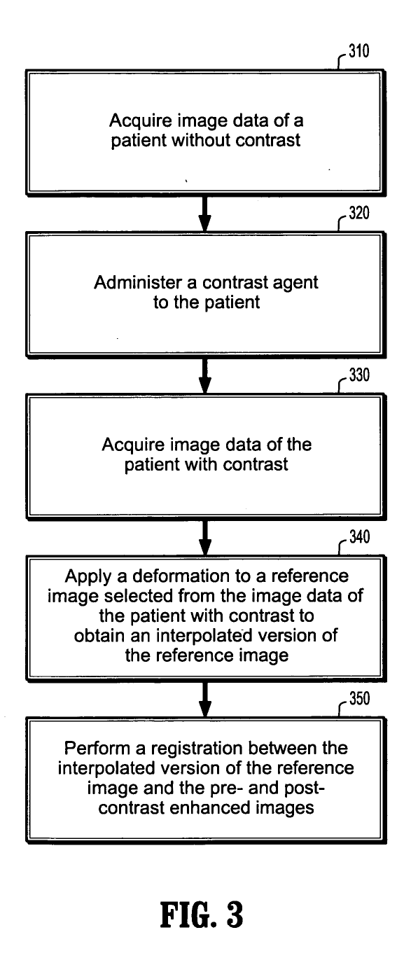

The PC 210, which may be a portable or laptop computer, a medical diagnostic imaging system or a picture archiving communications system (PACS) data management station, includes a CPU 225 and a memory 230, connected to an input device 250 and an output device 255. The CPU 225 includes an artifact reduction module 245 that includes one or more methods for reducing artifacts in motion corrected dynamic image sequences to be discussed hereinafter with reference to FIGS. 3-6B. Although shown inside the CPU 225, the artifact reduction module 245 can be located outside the CPU 225.

The memory 230 includes a RAM 235 and a ROM 240. The memory 230 can also include a database, disk drive, tape drive, etc., or a combination thereof. The RAM 235 functions as a data memory that stores data used during execution of a program in the CPU 225 and is used as a work area. The ROM 240 functions as a program memory for storing a program executed in the CPU 225. The input 250 is constituted by a keyboard, mouse, etc., and the output 255 is constituted by an LCD, CRT display, or printer.

The operation of the system 200 may be controlled from the operator's console 215, which includes a controller 265, for example, a keyboard, and a display 260. The operator's console 215 communicates with the PC 210 and the acquisition device 205 so that image data collected by the acquisition device 205 can be rendered by the PC 210 and viewed on the display 260. It is to be understood that the PC 210 can be configured to operate and display information provided by the acquisition device 205 absent the operator's console 215, using, for example, the input 250 and output 255 devices to execute certain tasks performed by the controller 265 and display 260.

The operator's console 215 may further include any suitable image rendering system/tool/application that can process digital image data of an acquired image dataset (or portion thereof) to generate and display images on the display 26Q. More specifically, the image rendering system may be an application that provides rendering and visualization of medical image data, and which executes on a general purpose or specific computer workstation. It is to be understood that the PC 210 can also include the above-mentioned image rendering system/tool/application.

FIG. 3 is a flowchart showing an operation of a method for reducing artifacts in motion corrected dynamic image sequences according to an exemplary embodiment of the present invention. As shown in FIG. 3, pre-contrast enhanced image data is acquired from a region of interest such as the breast of a patient (310). This is accomplished by using the acquisition device 205, in this example an MR scanner, which is operated at the operator's console 215, to scan, for example, a patient's breast thereby generating a series of 2D image slices associated with the breast. The 2D image slices are then combined to form a 3D image.

Although image data of the breast is acquired in this step it is to be understood that the image data may be acquired from any region of interest in the patient's body such as the patient's head, abdomen, legs, etc. In addition, although the region of interest may include a plurality of organs, image data of a specific organ such as the patient's liver, heart, lung, colon, etc. may also be acquired during this step.

Once the pre-contrast enhanced image data is acquired, a contrast agent, which is used to highlight specific areas of the patient so that organs, blood vessels, or tissues are more visible, is administered to the patient (320). In particular, a contrast agent such as iodine, barium, barium sulfate or gastrografin can be administered. It is to be understood, however, that any suitable contrast agent may be administered in this step. Further, the contrast agent may be administered in a number of ways, for example, through intravenous injection, oral or rectal administration, inhalation, etc.

After administering the contrast agent and waiting, for example, 20 minutes, until the agent has sufficiently transited through the patient's body, post-contrast enhanced image data is acquired from the region of interest (330). This is accomplished in essentially the same manner as described above with regard to step 310. However, in this step a plurality of images is sequentially acquired over spaced periods. The periods may be equally spaced, for example, two minutes apart. Once the post-contrast enhanced images are acquired, a reference image is selected and a deformation is applied thereto to obtain an interpolated version of the reference image (340).

This is accomplished, for example, by selecting the reference image either automatically or manually. The reference image can be manually selected, for example, by a physician, or automatically selected, for example, by a program that queries a DICOM field corresponding to an image that has the contrast agent. Once the reference image is selected, a deformation such as a fixed sub-pixel 2D translation is applied thereto. It is to be understood, however, that any deformation may be applied in this step, for example, a rotation, scaling or shearing may be performed here. However, the deformation should be minor, for example, it should be small enough so that it does not excessively distort the image and so that it is easy to recover.

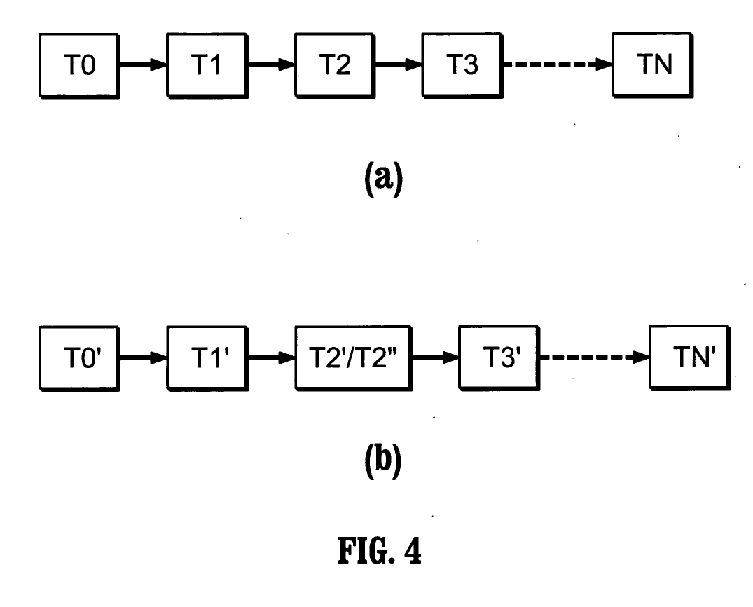

Once the reference image has been deformed to obtain an interpolated version thereof, a registration between the interpolated version of the reference image and the pre-contrast enhanced image and the post-contrast enhanced images is performed (350). The registration can be, for example, a non-rigid registration or any other area based or feature based image registration technique. A more detailed description of the registration will now be described with reference to FIG. 4.

As shown in FIG. 4, an image set T0 . . . TN represents an original perfusion image sequence with T0 being a pre-contrast enhanced image and T1 . . . TN being post-contrast enhanced images. Once a reference image has been selected (e.g., T2) and interpolated (e.g., T2′), the registration process begins. Here, image T0 is subtracted from T2′ to obtain a motion corrected image T0′, image T1 is subtracted from T2′ to obtain a motion corrected image T1′, image T2 is subtracted from T2′ to obtain a motion corrected image T2″, image T3 is subtracted from T2′ to obtain a motion corrected image T3′ and so forth until image TN is subtracted from T2′ to obtain a motion corrected image TN′.

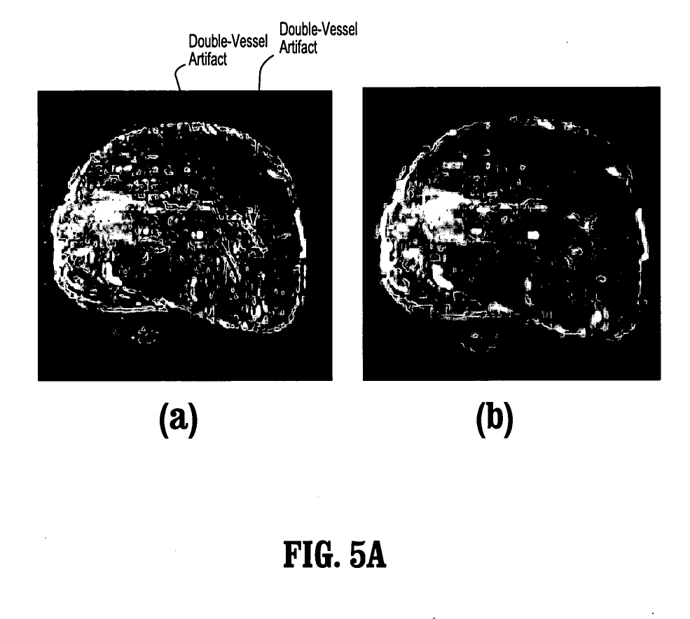

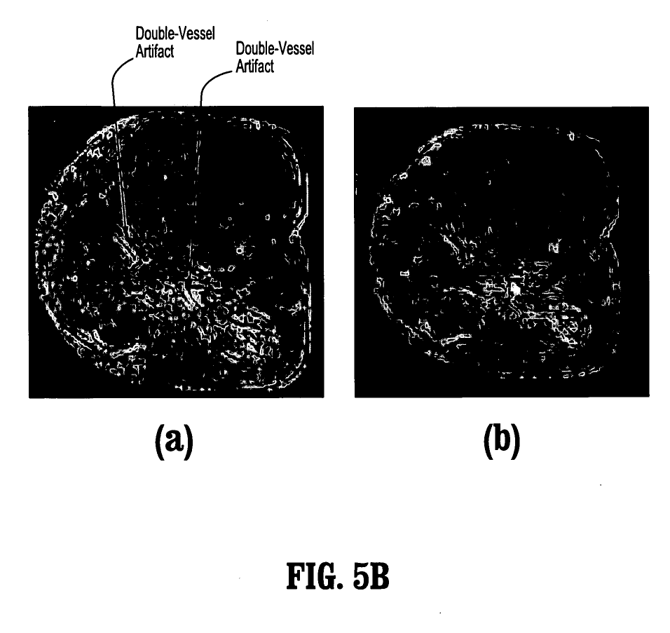

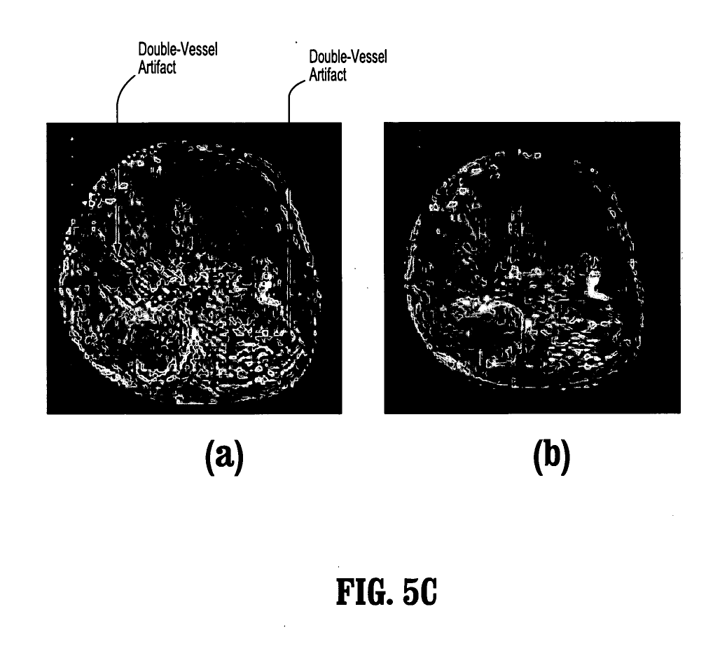

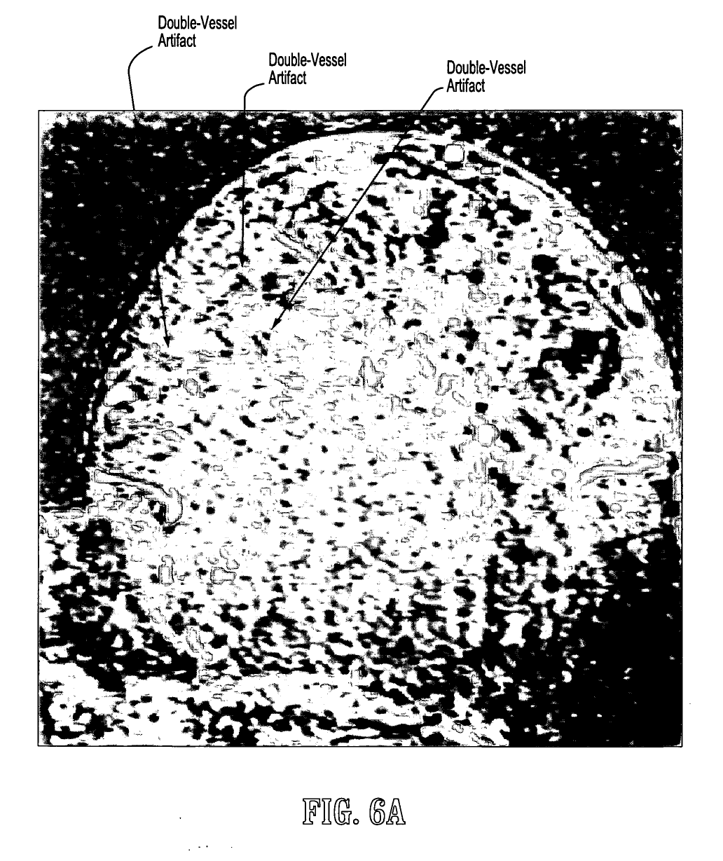

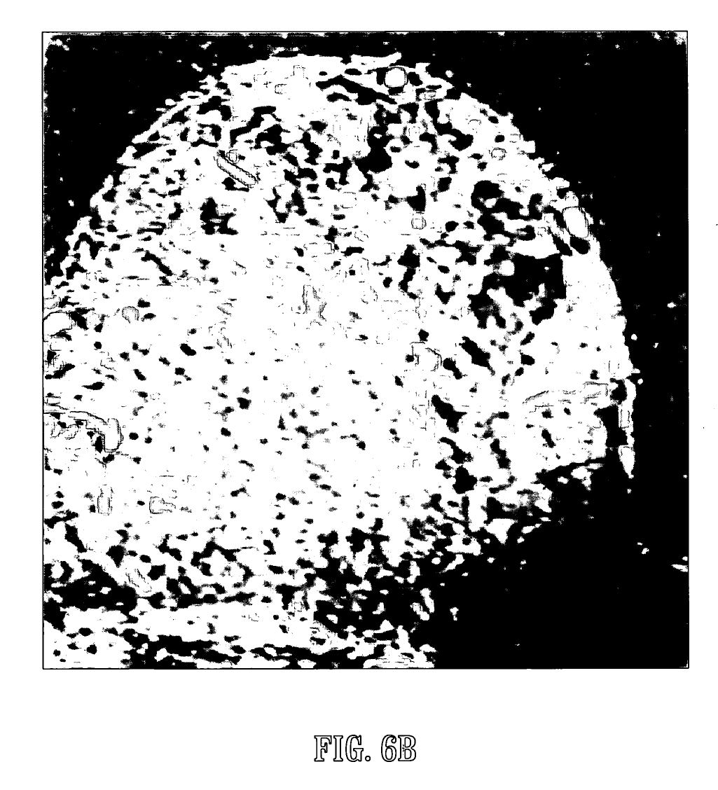

Once the registration process is complete, the motion corrected images can be displayed. Examples of several images (image b) motion corrected according to an exemplary embodiment of the present invention displayed next to conventionally motion corrected images (image a) are shown in FIGS. 5A-5C. As can be observed, the double-vessel artifacts are either completely removed or barely present in the images motion corrected according to an exemplary embodiment of the present invention. In another example shown in FIGS. 6A and 6B, even in a high-resolution image 512×512 as compared to the lower resolution 256×128 images of FIGS. 5A-5C, the double-vessel artifacts are removed when the method for motion correction according to an exemplary embodiment of the present invention is applied.

Thus, as shown in the FIGS. 5A-6B, the method for motion correction according to an exemplary embodiment of the present invention is quite effective in reducing the amount of double-vessel artifacts. Results of an experiment in which the method for motion correction according to an exemplary embodiment of the present invention was applied to 28 breast MR dynamic sequences is shown below in Table 1.

TABLE 1

| | |
|---|---|
| Motion | Artifacts |

| | | | |
|---|---|---|---|
| 7 | very strong | 6 | very marked |
| 6 | Strong | 5 | marked |
| 5 | Medium-strong | 4 | moderate-marked |
| 4 | Medium | 3 | moderate |
| 3 | small-medium | 2 | mild |
| 2 | small | 1 | very mild |
| 1 | very small | 0 | none |
| 0 | none | | |

| | | After | | |
|---|---|---|---|---|
| | | conventional | Double- | Double-vessel |
| | Amount of | motion | vessel | artifact after method |
| PID | motion | correction | artifact | of present invention |
| AB-27 | 1 | 0 | 0 | 0 |
| BK-8 | 1 | 0 | 0 | 0 |
| BR-12 | 7 | 1 | 6 | 2 |
| CNG-2 | 1 | 0 | 0 | 0 |
| JB-11 | 7 | 0 | 3 | 0 |
| MD-5 | 7 | 0 | 4 | 0 |
| OS-19 | 7 | 0 | 0 | 0 |
| TS-23 | 4 | 0 | 2 | 0 |
| HH-3 | 4 | 0 | 0 | 0 |
| WC-25 | 3 | 0 | 6 | 1 |
| WR-26 | 7 | 0 | 2 | 0 |
| DA-13 | 1 | 0 | 5 | 0 |
| DM-9 | 1 | 0 | 4 | 2 |
| FD-14 | 6 | 0 | 3 | 1 |
| GE-15 | 1 | 0 | 1 | 0 |
| HK-4 | 1 | 0 | 5 | 0 |
| HU-17 | 1 | 0 | 3 | 0 |
| KJ-1 | 1 | 0 | 2 | 0 |
| KV-18 | 1 | 0 | 2 | 0 |
| KW-29 | 1 | 0 | 1 | 0 |
| LB-28 | 6 | 1 | 3 | 0 |
| PD-20 | 1 | 0 | 2 | 1 |
| PE-21 | 0 | 0 | 2 | 1 |
| RG-6 | 2 | 0 | 4 | 0 |
| SH-22 | 2 | 0 | 1 | 0 |
| TT-24 | 6 | 0 | 3 | 0 |
| WH-31 | 0 | 0 | 4 | 0 |

In Table 1, the tested sequences had different amounts motion ranging from very small to very strong. It can be observed that the motion correction algorithm of the present invention did a good job in correcting for this motion, bringing it to none or very small in all cases. Further, although double-vessel artifacts were present in almost every conventionally motion corrected case, the amount of double-vessel artifacts present in the images motion corrected according to the exemplary embodiment of the present invention was dramatically reduced.

According to an exemplary embodiment of the present invention, a dynamic input image sequence can be preprocessed to reduced a double-vessel artifact. In doing so, a deformation field is applied to a selected reference image so that a set of frequencies represented in the reference image is similar to the set of frequencies of the remaining motion compensated images. This technique improves the quality of the subtraction that takes place during motion compensation and can thus be used either alone or in conjunction with a variety of methods designed to compensate for motion in perfusion sequences.

It should be understood that the present invention may be implemented in various forms of hardware, software, firmware, special purpose processors, or a combination thereof. In one embodiment, the present invention may be implemented in software as an application program tangibly embodied on a program storage device (e.g., magnetic floppy disk, RAM, CD ROM, DVD, ROM, and flash memory). The application program may be uploaded to, and executed by, a machine comprising any suitable architecture. It is to be further understood that because some of the constituent system components and method steps depicted in the accompanying figures may be implemented in software, the actual connections between the system components (or the process steps) may differ depending on the manner in which the present invention is programmed. Given the teachings of the present invention provided herein, one of ordinary skill in the art will be able to contemplate these and similar implementations or configurations of the present invention.

It should also be understood that the above description is only representative of illustrative embodiments. For the convenience of the reader, the above description has focused on a representative sample of possible embodiments, a sample that is illustrative of the principles of the invention. The description has not attempted to exhaustively enumerate all possible variations. That alternative embodiments may not have been presented for a specific portion of the invention, or that further undescribed alternatives may be available for a portion, is not to be considered a disclaimer of those alternate embodiments. Other applications and embodiments can be implemented without departing from the spirit and scope of the present invention. It is therefore intended, that the invention not be limited to the specifically described embodiments, because numerous permutations and combinations of the above and implementations involving non-inventive substitutions for the above can be created, but the invention is to be defined in accordance with the claims that follow. It can be appreciated that many of those undescribed embodiments are within the literal scope of the following claims, and that others are equivalent.

What is claimed is:

1. A method for reducing an artifact in a motion corrected image sequence, comprising:
applying a deformation to a reference image of a plurality of post-contrast enhanced images to obtain an interpolated version of the reference image; and
performing a registration between the interpolated version of the reference image and a pre-contrast enhanced image and the plurality of post-contrast enhanced images to obtain a plurality of motion corrected images.

2. The method of claim 1, wherein the pre-contrast enhanced image and the plurality of post-contrast enhanced images are acquired using a magnetic resonance (MR), computed tomography (CT), positron emission tomography (PET), single photon emission computed tomography (SPECT), fluoroscopic, x-ray or ultrasound technique.

3. The method of claim 1, wherein the pre-contrast enhanced image is an image acquired before a contrast agent has been administered to a patient and the plurality of post-contrast enhanced images are images acquired after the contrast agent has been administered to the patient.

4. The method of claim 1, wherein the pre- and post-contrast enhanced images are images of a region of interest in a patient.

5. The method of claim 1, wherein the deformation is a translation, rotation, scaling or shearing.

6. The method of claim 1, wherein the registration is a non-rigid registration.

7. The method of claim 1, wherein the registration comprises:
subtracting the pre-contrast enhanced image from the interpolated version of the reference image; and
subtracting the plurality of post-contrast enhanced images from the interpolated version of the reference image.

8. The method of claim 1, further comprising:
displaying one of the plurality motion corrected images.

9. The method of claim 1, of wherein the artifact is a double-vessel artifact.

10. A system for reducing an artifact in a motion corrected image sequence, comprising:
a memory device for storing a program;
a processor in communication with the memory device, the processor operative with the program to:
apply a deformation to a reference image of a plurality of post-contrast enhanced images to obtain an interpolated version of the reference image; and
perform a registration between the interpolated version of the reference image and a pre-contrast enhanced image and the plurality of post-contrast enhanced images to obtain a plurality of motion corrected images.

11. The system of claim 10, wherein the pre-contrast enhanced image and the plurality of post-contrast enhanced images are acquired using a magnetic resonance (MR), computed tomography (CT), positron emission tomography (PET), single photon emission computed tomography (SPECT), fluoroscopic, x-ray or ultrasound device.

12. The system of claim 10, wherein the pre-contrast enhanced image is an image acquired before a contrast agent has been administered to a patient and the plurality of post-contrast enhanced images are images acquired after the contrast agent has been administered to the patient.

13. The system of claim 10, wherein the pre- and post-contrast enhanced images are images of a region of interest in a patient.

14. The system of claim 10, wherein the deformation is a translation, rotation, scaling or shearing.

15. The system of claim 10, wherein the registration is a non-rigid registration.

16. The system of claim 10, wherein when performing the registration the processor is further operative with the program code to:
subtract the pre-contrast enhanced image from the interpolated version of the reference image; and
subtract the plurality of post-contrast enhanced images from the interpolated version of the reference image.

17. The system of claim 10, wherein the processor is further operative with the program code to:
display one of the plurality of motion corrected images.

18. The system of claim 10, wherein the artifact is a double-vessel artifact.

19. A method for reducing double-vessel artifacts in a perfusion image sequence of a region of interest in a patient, comprising:
acquiring a pre-contrast enhanced image of the region of interest;
acquiring a plurality of post-contrast enhanced images of the region of interest;
selecting a reference image from the plurality of post-contrast enhanced images;
deforming the reference image to obtain an interpolated version of the reference image; and
registering the interpolated version of the reference image to the pre-contrast enhanced image and the plurality of post-contrast enhanced images to obtain a plurality of motion corrected images.

20. The method of claim 19, further comprising:
administering a contrast agent to the patient.

21. The method of claim 19, wherein the reference image is selected automatically or manually.

22. The method of claim 19, wherein the region of interest is a head, breast, abdomen or leg of the patient.

23. The method of claim 19, wherein the reference image is deformed by performing a fixed sub-pixel 2D translation.

24. The method of claim 19, wherein the registration is a non-rigid registration.
